(19) United States
(12) Patent Application Publication
(10) Pub. No.: US 2026/0074276 A1
(43) Pub. Date: Mar. 12, 2026

(54) ELECTROLYTE WITH DUAL FUNCTION SALT ADDITIVE

(71) Applicant: LionVolt B.V., Eindhoven (NL)

(72) Inventors: Matthijs Holthuijsen, Eindhoven (NL); Bihag Anothumakkool, Eindhoven (NL); Freddy Roozeboom, Eindhoven (NL); Sandeep Unnikrishnan, Eindhoven (NL)

(21) Appl. No.: 19/116,287

(22) PCT Filed: Sep. 29, 2023
(86) PCT No.: PCT/NL2023/050509

§ 371 Date: Mar. 27, 2025

(30) Foreign Application Priority Data
Sep. 29, 2022 (NL) 2033186

(51) Int. Cl. H01M 10/056; H01M 4/02; H01M 4/04; H01M 4/1391; H01M 4/525; H01M 4/58; H01M 10/052; H01M 10/058

(52) U.S. Cl. CPC H01M 10/056; H01M 4/0404; H01M 4/045; H01M 4/1391; H01M 4/525; H01M 4/5825; H01M 10/052; H01M 10/058; H01M 2004/027; H01M 2004/028; H01M 2300/0082

(57) ABSTRACT

The present disclosure relates to an electrolyte product (1), formed as a solid or semi-solid layer, comprising a polymer-based matrix, having dispersed therein an amount of an electrolyte salt composition (4) and an amount of an additive salt composition (5). The disclosure further relates to a method of manufacturing a battery cell product, a battery cell product comprising the electrolyte product, and a battery product comprising a plurality of battery cell products.

### TECHNICAL FIELD AND BACKGROUND

The present disclosure relates to an electrolyte product, in particular a solid or at least semi-solid product, comprising a polymer-based matrix having dispersed therein; an amount of an electrolyte salt composition comprising an anode metal cation; and an amount of an additive metal salt composition configured to, upon partaking in a redox reaction, form a mixed metal alloy layer with the anode metal and a solid electrolyte interphase (SEI) layer. The disclosure further relates to a method of manufacturing a battery cell product, to the battery cell product comprising the electrolyte product, and to a battery product comprising a plurality of battery cell products.

Lithium (Li) metal is considered an important anode material for next-generation rechargeable batteries due to its high theoretical specific capacity (3860 mAh·g⁻¹) and the low reduction voltage (−3.04 V vs. the standard hydrogen electrode). However, dendritic Li formation, uncontrolled interfacial reactions, and large volume variations can in practice lead performance issues such as low Coulombic efficiency and, consequently, short cycling lifetime.

Designing artificial solid electrolyte interphase (SEI) films on the Li metal electrode shows great potential to solve the aforementioned problems and enable Li-metal batteries (LMBs) with prolonged lifetime.

Some attempts towards the provision of mixed metal layers to reduce Li-metal reactivity or the provision of protective solid electrolyte interphase layers are known from the art. Z. Zeng et al. (Journal of Power Sources, 451, 227730, 2020, discloses the use of an Zinc bis(2-ethyl hexanoate), as an additive for forming solid state lithium batteries. The additive is reported to enable formation of a LiZn alloy layer and/or to provide a plasticizing effect.

CN107665966A pertains to a lithium-sulfur battery. The battery comprises a multilayer composite separator and a liquid electrolyte composition The electrolyte is reported to comprise one or more of various lithium-based salts, including Lithium bis (trifluoromethylsulphonyl)imide (LiTFSI), as additive, which reportedly contributes to improve reduced the activity of the lithium anode, improve its stability, and reduce dendrite formation.

However, especially for solid or semi-solid batteries, there remains a need to improve on one or more of battery safety, stability, lifetime, while at least maintaining, preferably improving battery performance in terms of one or more of overall capacity and/or power density.

### SUMMARY

In accordance with an aspect of the present invention there is provided an electrolyte product. As will become clear from the specification herein the electrolyte product can be used to particular advantage, as a component of and/or in the manufacturing of a battery cell product and battery products comprising said cell products.

The electrolyte product is typically formed as a solid or semi-solid, e.g. gel, layer comprising a polymer-based matrix. The electrolyte product further comprises an amount of an electrolyte salt composition. The electrolyte salt is dispersed in the polymer matrix. The electrolyte salt comprises cations M^{I} of a suitable anode active metal composition and weakly-coordinating balance anions X^{I}. Due to their comparatively large redox potential preferred compositions include cations of one or more of the alkali and/or alkaline earth metals. The cations are preferably cations selected from the group elements consisting of: Na, K, Li, Mg and Cs.

The electrolyte product further comprises, at least initially prior to battery cycling, an amount of an additive salt composition. As will become clear from the specification herein the amount of additive salt can, at least partially, be advantageously consumed, e.g. upon a reaction with the anode metal, e.g. deposited or plating anode metal, typically an initial metal deposition or plating procedure. As will be appreciated from the specification herein the reaction of said additive salt advantageously yields reaction products that significantly improve battery properties including but not limited to performance, safety, and/or operable lifetime.

The additive salt composition comprises cations of a further metal M^{II} (the further metal being different from the first anode active metal M^{I}) and one or more balance anions X^{I} While the balance ions could be the same as the weakly-coordinating balance anions X^{I} it is strongly preferred that the balance ions differ from X^{I}.

The further metal ion is selected to have a higher reduction potential (less negative) than M^{I}, so that upon contact with anode metal the further metal ion is reduced to a metallic state. This with will then intermix, allow, with subsequently provided, e.g. deposited or plated, anode metal to from a mixed metal layer. At the same time balance ions X^{II} are selected to preferentially partake in an SEI-forming redox reaction upon contact with the anode metal (M^{I}) once provided. Providing an additive salt composition as described can advantageously improve performance and lifetime of a battery device, in particular a secondary anode metal battery—as a rechargeable Li-metal battery device, due to the dual functionality of the additive salt as provided herein.

Inventors found that the electrode product advantageously results when incorporated in a battery cell stack, in in-situ and in-operando formation of a protective and battery active hybrid layer formation, at a position proximate, i.e. close to, an anode of the cell stack (e. g a Li-metal anode). The active protective hybrid layer being positioned between, interfacing between an anode metal layer of the stack and the (remainder of) the electrolyte layer realizes one or more of the aims of performance, safety, and/or operable lifetime of a battery. As will become apparent from the present specification the in-situ generation of the protective layer, including the mixed metal layer and SEI component, provides multiple benefits that synergistically contribute to the aim of providing improved battery performance. For example, in addition to a reduced an apparent surface reactivity of the anode metal as provided by the mixed metal component, and the ion conductive and stabilizing properties of the SEI component inventors find that the combination provides a particularly favorable combination of interlayer adhesion and cycling stability. The SEI/mixed-metal components can advantageously be formed in-situ, e.g. upon an initial battery charging cycle. This advantageously mitigates or even eliminates a need for dedicate deposition steps, e.g. post anode metal deposition, which due to the high sensitivity and reactivity of anode metals (e.g. Li) can lead to adverse reactions, e.g. a result of contact with (traces of) humidity, dinitrogen, or carbon dioxide (forming Li-nitride and Li-carbonate) or other contaminants.

Without wishing to be bound by theory it is believed that both the electrolyte salt (M^{I}X^{I}) and the additive salt (M^{II}X^{II}) can advantageously jointly contribute to the formation of the protective hybrid layer. Respective portions of the electrolyte salt and additive salt composition as initially comprised in the electrolyte product can partake in respective redox reactions with an anode metal (e.g. metallic Li), e.g. as a result of an initial anode metal deposition step or an initial battery cycling procedure.

The dual functional additive salt may be consumed upon reaction with an anode metal, to form a mixed metal alloy layer and SEI layer. Both the alloy layer and SEI layer improve cycle life of the battery.

In particular the electrolyte salt (M^{I}X^{I}) and additive salt (M^{II}X^{II}) can form a mixed metal alloy layer, e.g. Liₓ(M^{II})₁₋ₓ, with and on top of the anode, e.g. a Li-containing anode. This can turn this formed layer into a tunable extra buffer/reservoir layer upon charge/discharge of the battery. The reservoir advantageously allows replenishing of anode metal fractions that are lost, i.e. no longer partaking from battery cycling, e.g. due to adverse side-reactions. In addition, this layer forms an ion conductive matrix film with excellent ion conductivity to/from the matrix, and also improves metal smoothening and adhesion (fixation) to the anode substrate, yielding a more uniform charge-discharge profile over the entire functional battery layer stack. It will be appreciated that the combinations of metal salt additives as disclosed in relation to the present invention are unique in combining and maximizing the functionalities of one single, new class of additives being dispersed in a layered fashion in a hybrid polymer-inorganic host matrix.

The anions comprised in the electrolyte salt and/or the additive salt, preferably and in particular the balance anions X^{II} supplied by the additive salt composition partake in an SEI (Solid Electrolyte Interphase)-forming reaction.

Unlike conventional electrolyte compositions, wherein the counter ion of the electrolyte salt is selected mainly on basis of performance as electrolyte the present invention allows addition/selection of a reagent, in the form of the balance ion X^{II} of the dual functional additive as based on its ability to partake in formation of a SEI layer having comparatively improved stability.

These additives may be salts with cations M^{II}, being metals unlike Li, such as In, Mg, Sn, Zn, Cs etc., and anions X^{II} (like bis(fluorosulfonyl)imide (FSI), TFSI, halides, nitrate, . . . ) that facilitate anode metal ion (e.g. Li⁺) diffusion through the electrolyte and also reinforce the chemical and structural stability of the layer (protective hybrid layer).

A further aspect of the present invention pertains to the electrolyte product, preferably as described above, wherein the solid or semi-solid layer is arranged as a multi-layer stack, whereby the additive salt composition is confined to, or at least predominantly contained in, an outer layer of the stack (i.e. a side that may be contacted externally, e.g. an anode-side current collector or a metal anode). Thus, the outer layer containing the additive dual functional salt can be assembled in close proximity to an anode. Further, by arranging the solid or semi-solid layer as a multi-layer stack, the formation and hybridization of a multi-layered polymeric electrolyte, like polyethylene oxide (PEO), can be split into multiple parts, wherein each of the multiple parts may comprise a distinct dual functional additive salt.

Because an electrolyte product as described herein can be advantageously used for the in-situ generation of a protective layer on an anode of a battery cell, e.g. upon an initial battery charging cycle, the electrolyte product preferably is suitable for manufacturing a battery cell product.

For the same reason, the electrolyte product is preferably in a virgin state, meaning that it has not undergone any battery cycling operation, when assembled into a battery product and used in charge and depletion cycles.

In a preferred embodiment, M^{I} is Li, M^{II} is an element selected from one or more metals of Group 2 or Group 12-15 elements, preferably one or more of Zn, Cs, Mg, Al, Ga, In, Sn, Ca, Ge, Cs and/or Bi, and wherein X^{II} is or comprises a halide, preferably fluoride, and/or a polyatomic anion comprising a central nitrogen atom. The listed Group 2 or Group 12-15 elements were found to be particularly advantageous for their affinity to alloy or at least form an admixture with metallic lithium. Suitable anions include PF₆, BF₄, preferably FSI (bis(fluorosulfonyl)imide), TFSI (bis(trifluoromethane)sulfonimide), DFOB (difluoro(oxalate)borate), more preferably nitrate (NO₃⁻) . The counter ions are selected on basis of an ability to partake in an SEI forming reaction, stabilizing the underlying electrode metal. SEI-layers with a relatively high nitrogen content, as obtainable from nitrogen containing counterions may form particularly stable protection layers. Preferred examples of additive salts include Zn(FSI)₂, MgF₂, CaF₂, In(NO₃)₃.

It will be understood that X^{I} can be selected by the skilled person from counter ions known from electrolyte salts. In some embodiments, X^{I} may be selected from the same list of compounds as X^{II}, whereby X^{I} and X^{II} are preferably not equal from reasons detailed herein.

The matrix can be selected from one or more compositions known in the field. Suitable materials include composition selected from one or more of, polyethers, polyfluorinated polymers, polyacrylates, polysiloxanes, and copolymers comprising one or more thereof. Typical materials include, PEO, Polyvinylidene fluoride (PVDF), Poly(vinylidene fluoride-hexafluoropropylene (PVDF-HFP), Poly(methyl methacrylate) (PMMA), and Polydimethylsiloxane (PDMS).

In preferred variations, the matrix comprises 10-50 % by weight of the electrolyte salt composition as based on a total weight of the polymer matrix and the electrolyte and other additives. The higher concentration improves electrochemical stability of the electrolyte layer and yields longer the cycle life. The upper limit is limited by practical considerations, e.g. a capacity of the matrix, and can be determined by the skilled person by routine experimentation.

In another or further preferred embodiment, the matrix comprises 1-30 % by weight of the additive salt composition as based on a total weight of the polymer matrix and the electrolyte and additive salts. In addition to usual considerations of electrolyte salt concentration within an electrolyte layer providing a high salt concentration of additive salt in a range of 1-30 wt % as based on a total weight of the polymer matrix and the electrolyte and additive salts, preferably higher, e.g. 2-30 wt %, more preferably 6-10 wt %, has an additional benefit of increased efficiency of alloy and SEI formation (e.g. during an initial charging routine). The reduced time to form the alloy/SEI layers, which is believed to relate to comparatively short diffusion pathways during layer formation, mitigates a potential of adverse side-reactions during, e.g. during to initial cycling. Advantageously, the higher the concentration of electrolyte salt and additive salt the more effective the alloy and stable SEI formation. Generally, M^{I} and M^{II} are added in a relative ratio in a range of 0.1-0.9 (mole fraction). In absolute terms the overall concentration of the prime salt and additive salt is in a range of 0.1-8 M.

In particular preferred variations the electrolyte salt composition comprises ≥4 mutually different ones of the weakly-coordinating balance anion (X^{I}). Inventors find that including multiple electrolyte salt compositions having mutually different ones of the weakly-coordinating balance anion can lead to formation of a particularly stable SEI layer, e.g. upon the initial stages of battery cycling. It will be understood that the number of mutually different ones of the weakly-coordinating balance anion (X^{I}) may be less than 4, e.g. 2, or 3 however the effect on SEI stability may be less beneficial.

It will be understood that the electrolyte product may comprise one or more additives known in the field such as plasticizers (to improve ion mobility). For example, plasticizers, such as succinonitrile also be admixed to the (quasi-)solid electrolyte layer(s) to offset any brittleness and stiffness of the new inorganic interlayer components in the entire battery layer stack. Alternatively, or in addition, the matrix may comprise one or more of inorganic particles, such as high-k dielectric particles (relative dielectric constant ϵ_{R}≥4, preferably≥100) and/or Li-ion conductive materials including nanoparticles and/or fibers. Alternatively, or in addition, the matrix may be provided with hollow compressible beads, e.g. hollow polymer beads, so as to allow the product to accommodate stress due to expansion/shrinkage processes during battery operation.

In particularly preferred embodiments the electrolyte product is arranged as the multi-layer stack, whereby the additive salt composition is confined to, or at least predominantly contained in, an outer layer of the stack. It will be understood that each layer is formed as a solid or semi-solid layer comprising a polymer-based matrix as disclosed herein. Confining, or at least predominantly providing the additive salt composition to an outer layer of the electrolyte product advantageously allows positioning said layer, with said additive salt, in close proximity to an anode side current collector of a battery stack. In other words, the multi-layer configuration allows the electrolyte product to arranged along a face of a first current collector whereby the outer layer of said stack faces the first current collector so that the dual functional salt is close to said current collector. This is advantageous for the in-situ generation of a protective layer on an anode of a battery cell product.

It will be understood that the electrolyte salt can, but needs not be, predominately contained in the remaining layers. An additional benefit of arranging the electrolyte product as a multi-layer stack is that the polymer material forming the matrix in respective layers may be different. That is, the polymer matrix in the layer retaining the additive salt composition, or at least the predominant portion of the total amount, and/or the one or more optimal additives may be chosen independently from the one or more remaining layers. Incorporating different polymers may be particularly advantageous for manufacturing. For example, when the electrolyte product is formed in a process comprising multiple solution-based processes, the polymers in the respective layers may be selected so that formed layers do not appreciably degrade or re-dissolve during subsequent solution processing steps. Alternatively, or in addition, the polymer in the layer comprising the additive salt may be selected to contribute to, partially partake, in the SEI-forming reaction, e.g. in combination with the one or more balance anions X^{II}.

The arrangement of the solid or semi-solid layer as a multi-layer stack, whereby the additive salt composition is confined to, or at least predominantly contained in, an outer layer of the stack, as described above, preferably also applies to the electrolyte product in a virgin state, i.e. prior to any initial battery cycling that the electrolyte product might be exposed to, because of the advantages of such a multi-layer stack arrangement in the in-situ generation of a protective layer on an anode of a battery cell. In case such a multi-layer stack arrangement would only be formed during or after the electrolyte product is exposed to battery cycling, these advantages would of the multi-layer stack arrangement would be absent or at least less pronounced.

An optional anode metal receptive layer may be arranged between the electrolyte product and the first current collector. The receptive layer containing a receptor material, receptive to sorb alkali metal (e.g. lithium)and/or alkaline earth metal (e.g. magnesium). The anode metal receptive layers may be suitably applied to one or more of a face of the current collector and/or an outward face of the electrolyte product (e.g. extending along the outer layer of the multi-layer stack comprising the dual functional salt as described above. Anode receptive materials are known in the field and can be applied using known methods. Suitable lithium metal receptive materials include layers comprising one or more of Si, Sn and graphite.

In some embodiments the first current collector comprises a plurality of aligned and electrically conductive pillar structures that extend from a support face of the first current collector, interspaced by at least the electrolyte product.

In line with further aspects of the present invention there is provided a method of manufacturing a battery cell product. In a preferred embodiment, the products is a secondary (also referred to as a rechargeable) anode metal battery product, e.g. a secondary Li-Metal battery cell. The method comprises at least: providing the electrolyte product, providing a first current collector and a second current collector and a cathode composition; and forming a layered assembly, whereby the second current collector extends along a face of the electrolyte product opposite the first current collector, and whereby the cathode composition extends between the electrolyte product and the second current collector.

The method may further include depositing an amount of alkali and/or alkali earth metal between the first current collector and the electrolyte product. The metal is selected from the group consisting of: Na, K, Li, Mg and Cs. Advantageously, the amount of alkali and/or alkali earth metal e.g. Lithium) can be provided by electroplating through the electrolyte product which has been pre-assembled onto the first current collector.

In one embodiment the electroplating is performed in-situ (in a complete cell battery or cell stack) with a formed layered assembly, whereby an inventory for the electroplating is provided by the cathode composition.

Alternatively, or in addition, the electroplating can be performed in a separate step prior to providing the cathode composition (in a partial stack comprising and the second current collector, in a plating bath, whereby an inventory for the electroplating is provided by the bath. Preforming the plating as a form an external inventory, prior to completing the cell stack, can advantageously result in the formation of a battery cell stack having an anode metal buffer as a plated layer. The plated anode metal can provide an additional anode metal inventory, in addition to an inventory supplied by a cathode composition. This anode metal layer provides multiple benefits. In addition to the benefits pertaining to formation of a mixed metal layer, and SEI formation, the provision of an anode metal layer acts as a buffer that can, upon progressive battery cycling, replenish lost anode metal. In addition the provided anode metal layer advantageously acts as a planarizing, wetting layer, for subsequently plated anode metal (e.g. lithium plated during initial battery charging).

In line with yet further aspects of the present invention there is provided a battery cell product. The battery cell product comprises the electrolyte product as disclosed herein. In a preferred embodiment, the electrolyte product is formed as the layered assembly as described herein. The cell product further includes a first current collector, a second current collector, and a cathode composition, whereby the second current collector extends along a face of the electrolyte product opposite the first current collector, and whereby the cathode composition extends between the electrolyte product and the second current collector.

In one embodiment the battery cell product further comprises an anode metal receptive layer arranged between the electrolyte product and the first current collector, the receptive layer containing a receptor material, receptive to sorb alkali metal and/or alkaline earth metal, wherein the receptor material comprises one or more of Si, Sn and graphite.

The first current collector may comprise a plurality of aligned and electrically conductive pillar structures that extend from a support face of the first current collector, interspaced by at least the electrolyte product.

In other or further embodiments, the second current collector comprises a plurality of aligned and electrically conductive pillar structures that extend from a support face of the second current collector, interspaced by at least the cathode composition.

Both of the first and second current collector can advantageously be provided in the form of a flexible film. The flexible film may include a flexible substrate (e.g. a plastic foil) that is provided along one or more sides with an electroconductive coating, e.g. a metal coating. Alternatively, or in addition, the first and/or second current collector can be provided as a metal foil. The anode-side current collector (first current collector) preferably comprises copper (e.g. as coating or Cu-foil). Copper foil/copper coated flexible substrates can be particularly suitable for Li-metal battery applications and/or allow large-scale manufacturing processes, e.g. roll-to-roll manufacturing. In addition, copper comprising, or copper coated surfaces are known to be particularly suitable substrates for the formation of a plurality of aligned and electrically conductive pillar structures that extend. E.g. by processes known in the field directed to the controlled growth of carbon nanotubes.

In relation to an aspect of the present invention the battery cell product further includes: an anode layer comprising an alkali metal and/or alkali earth metal selected from the group consisting of: Na, K, Li, Mg and Cs, said anode layer extending between the first current collector and the polymer-based matrix; a mixed metal alloy layer, said mixed metal alloy layer extending between the anode layer and the electrolyte product; and an SEI layer extending between the mixed metal alloy layer and the polymer-based matrix. The anode layer may be provided as an additional layer, prior to an initial battery cycling stage (e.g. by electroplating from a separate plating bath or coated by other coating techniques, e.g. in case of Si or Sn). Alternatively, or in addition, the anode layer may be provided as a result of reduction products from an initial charging cycle.

It will be appreciated that the dual salt additive in the electrolyte product may be largely or completely consumed upon providing the anode metal layer. Accordingly, in one embodiment the said mixed metal alloy layer comprises a mixture of the alkali metal and/or alkali earth metal and a further metal reduced from at least a portion, optionally all, of the M^{II} cations as initially comprised in the electrolyte product. Likewise, the SEI layer comprises at least a portion, optionally all, of the X^{II} anions or reaction products thereof as initially comprised in the electrolyte product, said electrolyte product comprising an optional remainder of M^{II} and/or X^{II}.

Note that the battery cell product may for instance be distinguished from known cells because of the presence of an electrolyte product in a multi-layer stack arrangement layer even when the cell is still in virgin state, i.e. prior to any battery cycling operation.

According to yet a further aspect there is provided a battery product. Said battery product comprises one or more of the battery cell products. In accordance with the battery product there may be provided a cathode side contact, anode side contact, and battery housing. In some embodiments, the one or more battery cell product is arranged in a pouch.

In some embodiments, the one or more battery cells are arranged in series, and/or in parallel in correspondence with a desired potential output of the battery product.

### BRIEF DESCRIPTION OF DRAWINGS

These and other features, aspects, and advantages of the apparatus, systems and methods of the present disclosure will become better understood from the following description, appended claims, and accompanying drawing wherein:

FIG. 1 provides a cross-section side view of an electrolyte product;

FIG. 2 provides a cross-section side view of an electrolyte product;

FIG. 3 provides a cross-section side view of an electrolyte product;

FIG. 4 provides a cross-section side view of an electrolyte product;

FIG. 5 provides a cross-section side view of an electrolyte product;

FIG. 6 illustrates a method of manufacturing a battery cell product;

FIGS. 7A, 7B, 7C and 7D provide cross-section side views of a battery cell product during different manufacturing steps;

FIG. 8 provides a cross-section side view of a battery cell product;

FIG. 9A and B provide cross-section side views of protective layers, comprising a mixed metal alloy layer and an SEI layer; and

FIG. 10 provides a cross-section side view of a battery product comprising a plurality of battery cell products.

### DESCRIPTION OF EMBODIMENTS

Terminology used for describing particular embodiments is not intended to be limiting of the invention. As used herein, the singular forms “a”, “an” and “the” are intended to include the plural forms as well, unless the context clearly indicates otherwise. The term “and/or” includes any and all combinations of one or more of the associated listed items. It will be understood that the terms “comprises” and/or “comprising” specify the presence of stated features but do not preclude the presence or addition of one or more other features. It will be further understood that when a particular step of a method is referred to as subsequent to another step, it can directly follow said other step or one or more intermediate steps may be carried out before carrying out the particular step, unless specified otherwise. Likewise, it will be understood that when a connection between structures or components is described, this connection may be established directly or through intermediate structures or components unless specified otherwise.

By the term “non-coordinating or weakly coordinating anion” it is meant that the anion does not form a coordinative bond with the metal in an aqueous solution. Examples of non-coordinating or weakly coordinating anions include trifluoromethane sulfonate ([CF₃SO₃]⁻), hexafluorophosphate ([PF₆]⁻), tetrafluoroborate ([BF₄]⁻), perchlorate ([ClO₄]⁻), teflate ([OTeFs]⁻), BArF ([B(ArHₓFy)4]⁻, where Ar is an aryl and x+y=5, e.g., [B(C6F₅)4]⁻, tosylate ([CH3C₆H₄SO₃]⁻), FSI ([(FSO₂)₂N]⁻), and TFSI ([CF₃SO₂)₂N]⁻).

The invention is described more fully hereinafter with reference to the accompanying drawings, in which embodiments of the invention are shown. In the drawings, the absolute and relative sizes of systems, components, layers, and regions may be exaggerated for clarity. Embodiments may be described with reference to schematic and/or cross-section illustrations of possibly idealized embodiments and intermediate structures of the invention. In the description and drawings, like numbers refer to like elements throughout. Relative terms as well as derivatives thereof should be construed to refer to the orientation as then described or as shown in the drawing under discussion. These relative terms are for convenience of description and do not require that the system be constructed or operated in a particular orientation unless stated otherwise.

The electrode product 1 will now be explained in further detail with reference to FIGS. 1 to 5.

The electrode product 1, e.g. as shown in FIGS. 1, 2, 3, 4, and 5, is, in general terms, formed as a solid or semi-solid layer 2 comprising a polymer-based matrix 3 having dispersed therein an amount of an electrolyte salt composition 4 and an amount of an additive salt composition 5.

Solid or semi-solid is to be interpreted as a distinct from liquid electrolytes. Instead, solid or semi-solid includes materials and compositions that are in a solid or quasi-solid aggregation condition (at room temperature). Solid or semi-solid explicitly also includes materials known as polymer electrolytes, e.g. dry polymer electrolytes which differ from liquid electrolytes in that salt additive(s) is (are) is dissolved directly into the solid medium. Solid or semi-solid explicitly also includes so-called gel electrolytes which may be understood as liquids that are contained in a flexible lattice framework (the polymer matrix). The polymer matrix forms a continuous phase holding or supporting more or more potentially liquid additives, such as an ionic liquid and/or one or more solvents. While similar to solids in some respects, such as having the ability to support their own weight and hold their shapes, a quasi-solid also shares some properties of liquids, such as conforming in shape to something applying pressure to it. In addition the solid or semi-solid electrolyte may comprise one or more solid, e.g. ceramic, particles.

The electrolyte salt composition 4 comprises cations of an alkali metal and/or an alkaline earth metal element M^{I} selected from a group consisting of: Na, K, Li, Mg and Cs; and a weakly-coordinating balance anions X^{I}. The additive salt composition 5 comprises cations of a further metal M^{II} having a higher reduction potential than M^{I}; and one or more balance anions X^{II} different from X^{I} and selected to partake in an SEI-forming redox reaction with M^{I}. The balance ions typically have a valance of negative one. The additive salt composition 5 serves a dual function, therein that the additive salt partakes in a redox reaction with an anode element in metal state (e.g. Li⁰). The additive salt is at least partially consumed forming a protective layer comprising a mixed metal alloy phase and SEI phase. The layer of mixed metal alloy phase and SEI phase can advantageously from a structure, e.g. a bilayer structure, that mitigates adverse reactions of underlaying further anode metal (e.g. Li), in particular during manufacturing/assembly of a closed battery cell assembly. In addition the protection layer serves as a homogenization layer, wetting layer, for subsequently deposited anode metal, e.g. during battery cycling, mitigating uneven anode metal plating/de-plating, especially during initial battery cycling processes. FIG. 9A and B provide cross-section side views of protective layers, comprising a mixed metal alloy layer 1021 and an SEI layer 1022. Depending on a relative reactivity, process conditions, and/or directionality of on anode metal (e.g. Li(0)) exposure onto the film, the protective layer 1020 may be characterized by mixed of multi-layer structure. Typically, the protective layer is formed with a side A comprising a predominant fraction of the alloy or mixed metal composition facing an anode current collector 1025 and side B composing a predominant fraction of the SEI composition that faces away from the anode-side current collector.

The thickness of the protective layer varies with an initial amount of additive salt added to the electrolyte product. The thickness is generally at least 0.5 μm and can extend up to several micrometers, typically ≤10 μm

Anode metal ions supplied during an initial charging cycle migrate through the protection layer, towards the anode side current collected for plating forming a battery active anode metal layer that is covered/protected by the protection layer. Both the mixed metal alloy layer and SEI layer thereby serve to improve cycle life of the battery.

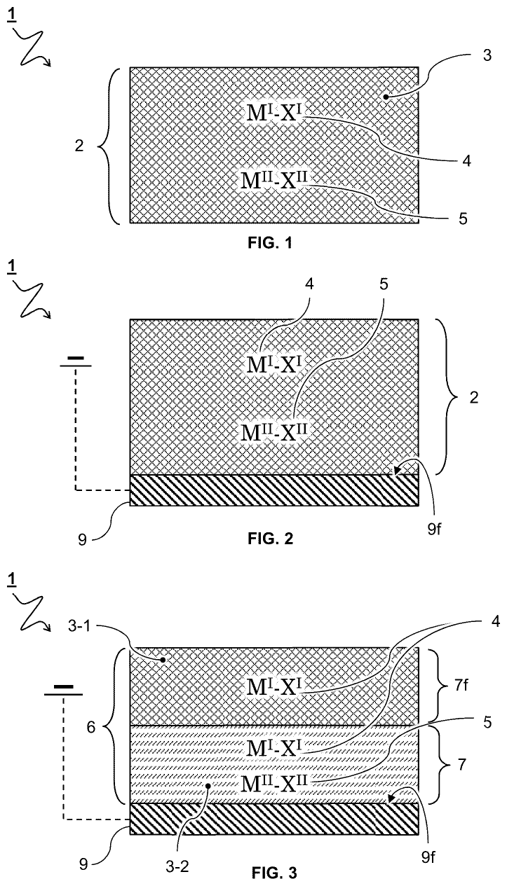

In FIG. 2, the solid or semi-solid layer 2, comprising the polymer based matrix 3, is depicted arranged along a face 9f of an electrically conductive first current collector 9. As described hereinabove the first current collector can be a metal foil (e.g. a copper foil) or a metal coating, e.g. a copper film, deposited on carrier, preferably a flexible carrier, e.g. a polymer foil.

The solid or semi-solid layer 2 may include a block co-polymer and/or a mixture of different polymers. Typically the polymer matrix comprises one or more materials selected from the group of polyvinylidene fluoride, polydimethylsiloxane, polyethylene oxide, polymethyl methacrylate, polyethylene diacrylate, polyacrylonitrile, hexafluoropropylene, and copolymers thereof. The average molecular weight (Mw) of the polymer materials is generally between 10000 and 1000000 g/mol. The polymer matrix provides a network which confines fillers, while allowing the metal salts, to diffuse as their ions between opposing faces of the solid or semi-solid layer 2.

By dispersing metal salts, e.g. Li-salts [Li⁺-X^{I}], into a polymer based matrix, an ion conductive matrix film can be formed, with far better ion conductivity, and improved metal smoothening of, and adhesion to, the substrate e.g. a Cu(Li) substrate.

In a further embodiment, the solid or semi-solid layer 2 is arranged as a multi-layer stack 6, e.g. as shown in FIG. 3. In such a multi-layer stack 6 configuration, the additive salt composition 5 is confined to, or at least predominantly contained in, an outer layer 7 of the stack 6. By confining the additive salt 5 to an outer layer 7 of the stack, the stack 6 may be arranged onto a first current collector, such that the dual functional additive salt composition is in close proximity to the first current collector, wherein the first current collector may be e.g. an anode. The proximity of the additive salt to the first current collector, or anode, can advantageously improve a rate at which an alloy layer and SEI layer is formed.

It will be appreciated that one or more plasticizers, e.g., succinonitrile, may be admixed to the solid or semi-solid layer 2, in any or all of the layers comprised in the multi-layer stack 6. These plasticizers act to offset any brittleness and stiffness of the components, in the entire electrolyte product 1, as well as a battery cell product formed thereof. It will also be appreciated that the solid or semi-solid layer 2 may comprise further additives, including an amount of liquid carriers such as ionic liquid and/or organic solvents, or inorganic nanoparticles including fibers, hollow compressible beads, etc. It may be envisioned that the electrolyte product 1 further includes inorganic solid electrolytes, such as LLZO (LiLaZrO), and/or other crystalline, glass, and/or glass-ceramic electrolytes, such as reviewed in A. K. Mishra et al., Review-Inorganic Solid State Electrolytes: Insights on Current and Future Scope, J. Electrochem. Soc. 168, 080536 (2021), which is hereby incorporated by reference In a preferred embodiment, the metal ion conductive inorganic composition comprises or essentially consists of a ceramic composition.

Preferred compositions include Lithium Aluminum Titanium Phosphate (LATP), Lithium Aluminum Germanium Phosphate (LAGP), Lithium Lanthanum Zirconium Oxide (LLZO), Halide electrolytes (e.g., Li₃₋ₓM₁₋ₓZrₓCl₆ M=Y, Er), Sulphide electrolytes (e.g. Li10GeP2S12, Li6PS5X (X=Cl, Br or I), 67(75Li2S-25P₂S₅)-33LiBH4, 30Li2S-26B₂S₃-44Lil) or derivatives and/or mixtures thereof, Lithium hydroborate including but not limited to closo-borate, closo-carbaborate and their derivatives and/or mixtures thereof

The layers of the multi-layered stack 6, may be interspaced with an optional interfacial layer.

As depicted in FIGS. 1, 2, 3 and 4, the electrolyte salt 4 comprises M^{I} and X^{I}, and additive salt 5 comprises M^{I} and XU. In one embodiment, M^{I} is Li, M^{I} is an element selected from one or more metals of Group 2 or Group 12-15 elements, preferably one or more of Zn, Cs, Mg, Al, Ga, In, Sn, Ca, Ge, Cs, and/or Bi. The balance ion(s) and X^{II} is a halide, preferably fluoride, or a polyatomic anion comprising a central nitrogen atom, such as PF₆, BF₄, preferably FSI, TFSI, DFOB, more preferably nitrate. The listed M^{II} cations were chosen based on their suitability for forming an alloy with Li. All these elements have a higher reduction potential than lithium and will reduce to their metal state upon a redox reaction with Li(0). The listed X^{II} anions were specifically chosen based on their ability to partake in a stable SEI forming reaction.

In one embodiment, the matrix 3 comprises 0.1-10 %, preferably 1-10 % by weight of the additive salt composition 5 as based on a total weight of the polymer matrix 3 and the electrolyte 4 and additive salt(s) 5. Providing a higher concentration of additive salt composition 5, in turn provides a more, possibly excess, MU and X^{II} ions, which may advantageously lead to more effective alloy and stable SEI layer formation. A thickness/amount of the mixed metal layer (alloy) may be suitably tuned by an amount of additive salt as initially comprised in the electrolyte product, e.g. in the layer 7 that is closest to the first current collector. Preferably, the mixed metal layer is a conformal layer having a thickness no less than 20 nm, preferably thicker, e.g. >50 nm, to reduce a number of potential point defects. An upper limit can be defined by a desired energy density range (Wh/unit volume) of the target battery cell. The higher the amount of additive metal (other than lithium) the lower the overall energy density of the resulting cell. Typically the thickness of the mixed metal layer is ≤1 μm, preferably ≤500 nm, e.g. in a range of 100-400 nm. The concentration of the additive salt in the electrolyte in accordance with a given layer thickens can be determined by routine experimentation.

Yet another aspect of the present invention relates to the electrolyte product, wherein the electrolyte salt composition 4 comprises ≥4, preferably ≥5, more preferably ≥6, most preferably ≥7 mutually different ones of the weakly-coordinating balance anion X^{I}. The addition of more types of weakly-coordinating balance anions was surprisingly found to further improve the life-cycle of a battery cell product.

In one embodiment the matrix 3 comprises 5-50 %, preferably 10-50 % by weight of the electrolyte salt composition 4, as based on a total weight of the polymer matrix 3 and the electrolyte 4 and additive salts 5. The higher concentration of electrolyte salt composition improves electrochemical stability of the electrolyte layer and yields a longer cycle life of a battery cell product. The upper limit is limited by practical considerations.

As depicted in FIG. 3, in some embodiments the electrolyte product 1 is arranged along a face 9f of a first current collector 9 whereby, if the solid or semi-solid layer 2 is arranged as the multi-layer stack 6, the outer layer 7 of said stack 6 faces the first current collector 9. The further layers 7f of the stack 6 face away from the first current collector 9. As discussed previously, this arrangement ensures proximity of the additive salt composition 5 to the first current collector 9, which improves improve the rate at which an alloy layer and SEI layer is formed. As discussed, the polymers forming the matrices 3-1, 3-2 in the respective layers of the stack 6 may be the same but can be different from each other (independently chosen). In general terms the outer layer 7 (to be positioned closest e.g. in direct contact with an anode side current collector) of the stack comprises both the additive salt (M^{II}X^{II}) and the electrolyte salt (M^{I}X^{I}). The additional layers 7f comprise at least the electrolyte salt (M^{I}X^{I}). Of course, one or more of the additional layers may comprise an amount of the same or a further one of the additive salt composition. For multilayered electrolyte products 1 that are apparently suitable and configured for manufacturing of a Li-metal battery product the electrolyte salt comprises or essentially consists of a Li cation as metal salt M^{I} in combination with a suitable weakly coordination anion X^{I} as disclosed herein (e.g. FSI, TFSI, halide, nitrate, etc.). The additive salt comprises or essentially consists of a metal cation M^{I} other than Li and having a high reduction potential (less negative) as disclosed herein, and a stabilizing anion different than X^{I} and selected to partake in an SEI-forming reaction as disclosed herein.

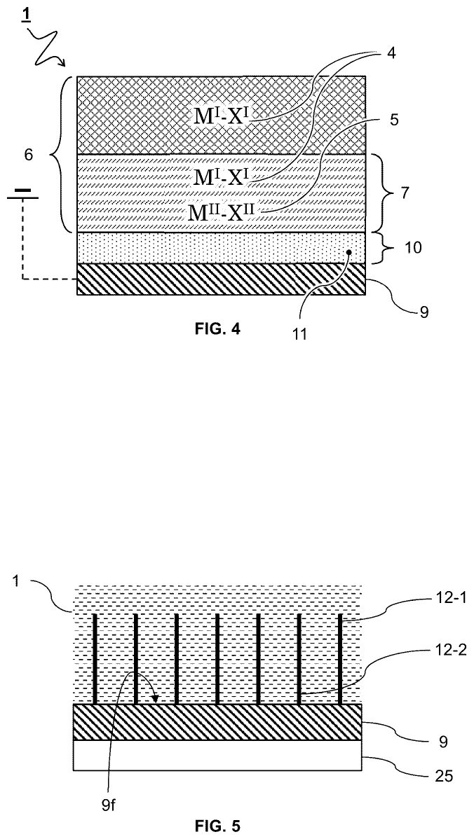

As shown in FIG. 4, an optional anode metal receptive layer 10 may be arranged between the electrolyte product 1 and the first current collector 9, the receptive layer 10 containing a receptor material 11. The receptor material 11 is receptive to sorb alkali metal and/or alkaline earth metal. For Li-metal batteries the anode metal receptive layer may comprise one or more of Si, Sn and graphite, which are each known for their ability in the field as Li-receptive compositions. The receptive layer 10 can advantageously facilitate ion diffusion through the electrolyte product, and/or a battery cell product. The receptive layer 10 can sorb, and distribute therein, an anode metal, e.g. Li, and thereby mitigate or prevent the formation of “dead” zones of insulated, inactive anode metal. Of course, a receptive layer can be applied with corresponding effect on other embodiments as disclosed herein, including but not limited to embodiments as described in relation to FIGS. 1, 5, and 8.

In yet another embodiment, as shown in FIG. 5, the first current collector 9 comprises a plurality of aligned and electrically conductive pillar structures 12, that extend from a support face 9f of the first current collector 9, interspaced by at least the electrolyte product 1. The plurality of aligned and electrically conductive pillar structures 12 give rise to a 3D structured current collector. The 3D structure results in increased contact area between the first current collector 9 and at least the electrolyte product 1, which in turn yields an increased current flowing between the components. The electrically conductive pillar structures 12-1, 12-2 can be embodied as metal or metal coated pillars. Alternatively, or in addition, the electrically conductive pillar structures 12-1, 12-2 can be embodied as carbon nanotubes or carbon nanotubes structures.

It will be understood that the electrolyte product can be arranged between a cathode and an anode, to provide ion transport, from the cathode side towards the anode side during a charging cycle of the battery and vice versa during discharging.

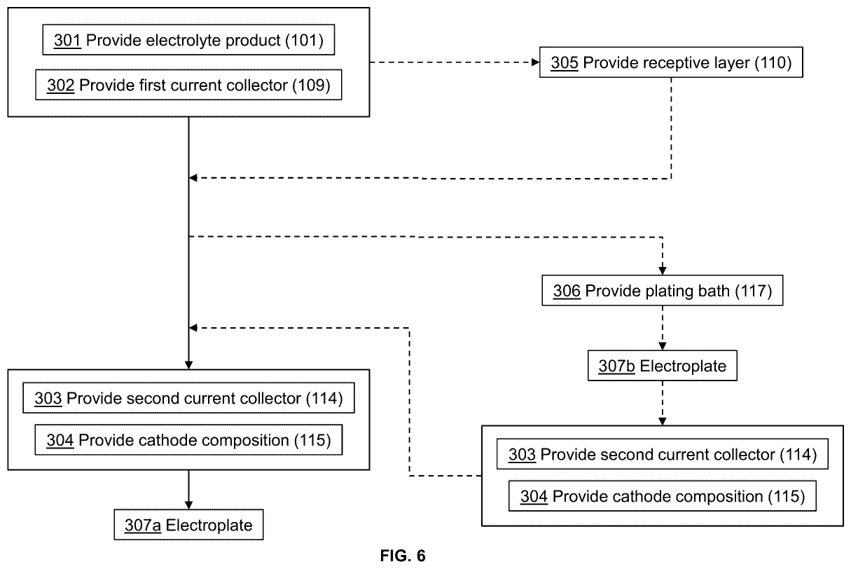

In line with further aspects of the present invention, as illustrated in the flow diagram of FIG. 6, there is provided a method of manufacturing a battery cell product. The method generally includes providing or manufacturing 301 an electrolyte product as disclosed herein. The electrolyte product can be suitably provided using one or more dry and/or wet processing methods. Including, but not limited to wet-deposition of a solution comprising the polymer matrix or a precursor thereto (e.g. a curable monomer composition), followed by drying said composition. Suitable wet-deposition methods include but are not limited to spray casting, spin coating, and/or dip coating. Solid additives, e.g. high-k dielectric particles, may be suitably added, e.g. suspended, to said liquid. Salts, including the electrolyte salt and additive salt composition may be added, e.g. dissolved, to said liquid. Alternatively, or in addition, the salts may be added, e.g. infused from a separate solution or as an ionic liquid, following initial polymer layer deposition. For a multi-layer stack 6 (e.g. as illustrated in FIG. 3) the stack of respective layers can, e.g., be formed by depositing a respective layer onto a previously deposited layer.

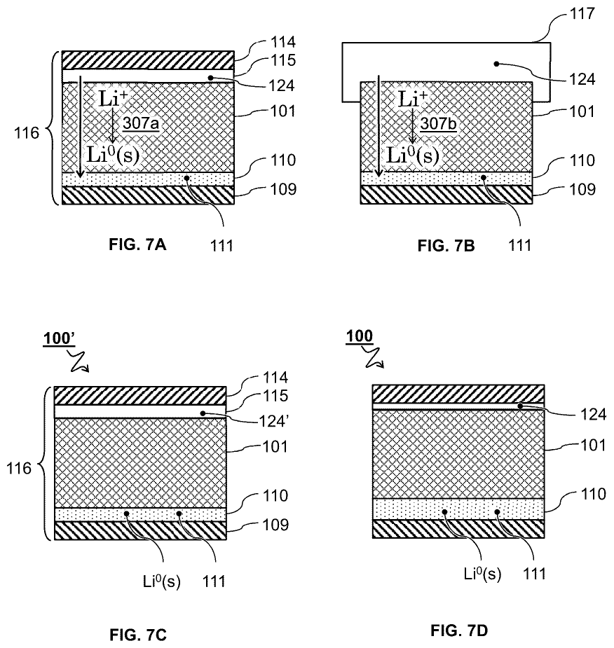

In preferred embodiments the electrolyte product can be provided directly onto a current collector substrate (e.g. the first carrier substrate such as a Cu foil). Alternatively, the electrolyte product may be formed on a carrier substrate, e.g. a temporary carrier for later use. Accordingly, in one embodiment, the method comprises: providing the electrolyte product 101 in a step 301, providing a first current collector 109 in a step 302, providing a second current collector 114 in a step 303, and providing a cathode composition 115 in a step 304; and forming a layered assembly 116 (e.g. as illustrated in FIG. 7A), whereby the second current collector 114 extends along a face of the electrolyte product 101 opposite the first current collector 109, and whereby the cathode composition 115 extends between the electrolyte product 101 and the second current collector 114. In one embodiment, forming the layered assembly 116 includes adhering the electrolyte product 101 to the first current collector 109, e.g. by coating or laminating the electrolyte product 101 onto the first current collector 109, wherein the first current collector is e.g. a metal current collector. In some embodiments, the current collectors are elongate metal foils or metal-coated polymer foils, for example copper foils.

Cathode compositions are known in the field. For lithium metal batteries suitable compositions include, but are not limited to “layered lithiated transition metal oxides” such as LiCoO2, but preferably higher energy density cathode materials like LMNC (LiNixCoyMnzO2), LFP (LiFePO4) and oxides containing vanadium pentoxides, and polyanion-type materials”. For exemplary Cathode Materials for Lithium-ion Batteries reference is made to a review by A. O. Soge et al in J. of New Materials for Electrochemical Systems, 24, 229 (2021), which is hereby incorporated by reference.

In one embodiment, the layered assembly 116 further comprises an optional anode metal receptive layer 110, provided in a step 305, arranged between the electrolyte product 101 and the first current collector 109, the receptive layer 110 containing a receptor material 111, receptive to sorb alkali metal and/or alkaline earth metal, wherein the receptor material 111 comprises one or more of Si, Sn and graphite. If a receptive layer 110 is used, forming the layered assembly 116 includes adhering the electrolyte product 101 to the receptive layer 110, e.g. by coating or laminating the electrolyte product 101 onto the receptive layer 110.

It will be appreciated that the steps need not necessarily be performed in the depicted order. The constituents may be assembled or even build upon each other in any suitable order.

FIGS. 7A to 7C depict further embodiments, wherein the method includes depositing an amount of alkali metal and/or alkali earth metal selected from the group consisting of: Na, K, Li, Mg and Cs between the first current collector 109 and the electrolyte product 101. The amount of alkali metal and/or alkali earth metal is provided by electroplating 307a/307b through the electrolyte product which has been pre-assembled onto the first current collector.

FIG. 7A shows one embodiment wherein the electroplating 307a is performed in-situ with a formed layered assembly 116, whereby an inventory 124 for the electroplating 307a is provided by the cathode composition 115. In the embodiment shown the anode metal (Li(s)) is sorbed by an optional silicon layer (Li-receptive layer 110).

FIG. 7B shows an alternative embodiment wherein the electroplating 307b is performed in a separate step prior to providing the cathode composition 115 and the second current collector 114, in a plating bath 117, whereby an inventory 124 for the electroplating 307b is provided by the bath 117.

FIG. 7C shows a battery cell product in a virgin state 100′ (Such a battery cell product is considered to be in a virgin state directly upon completion of the manufacturing steps, including electroplating 307b to, but prior to initial or further plating of anode metal from the cathode composition.

Depending on a charging level the amount of the anode metal ion comprised in the cathode composition decreases from an initial inventory 124′. FIG. 7D schematically depicts the assembly of 7C in a comparatively more charged state wherein the respective amounts of anode metal ion and anode metal comprised at the cathode/anode side of the stack are represented by changes in thickness of the respective layers.

In a preferred embodiment, as depicted by the process diagram in FIG. 6, the electroplating 307b is first performed in a separate step prior to providing the cathode composition 115 and the second current collector 114, in a plating bath 117, whereby an inventory 124 for the electroplating 307b is provided by the bath 117; where after the cathode composition 115 and the second current collector 114 is provided, and a further electroplating step 307a is performed in-situ with a formed layered assembly 116, whereby a further inventory 124′ for the electroplating 307a is provided by the cathode composition 115.

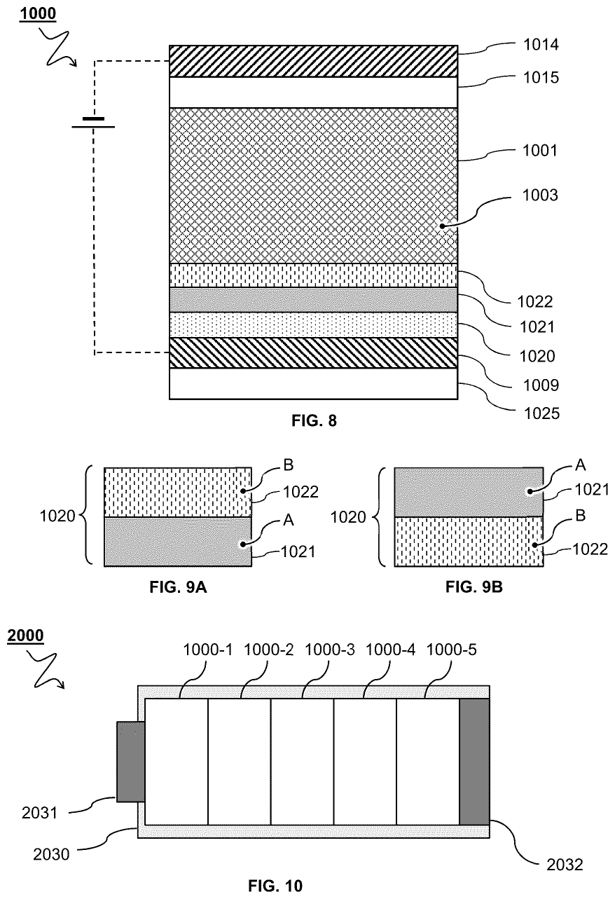

In line with yet further aspects of the present invention, as depicted in FIG. 8, there is provided a battery cell product 1000, comprising the electrolyte product 1001, formed in a layered assembly 1016 further including a first current collector 1009, a second current collector 1014, and a cathode composition 1015, whereby the second current collector 1014 extends along a face of the electrolyte product 1001 opposite the first current collector 1009, and whereby the cathode composition 1015 extends between the electrolyte product 1001 and the second current collector 1014. It will be appreciated that the first current collector 1009 can be provided on a support substrate 1025.

In one embodiment, not shown, the battery cell product 1000 further comprises an anode metal receptive layer arranged between the electrolyte product 1001 and the first current collector 1009, the receptive layer 1010 containing a receptor material, receptive to sorb alkali metal and/or alkaline earth metal, wherein the receptor material comprises one or more of Si, Sn and graphite.

The first current collector 1009 may comprise a plurality of aligned and electrically conductive pillar structures that extend from a support face of the first current collector 1009, interspaced by at least the electrolyte product 1001.

In another embodiment, the second current collector 1014 comprises a plurality of aligned and electrically conductive pillar structures that extend from a support face of the second current collector 1014, interspaced by at least the cathode composition 1015.

In yet another embodiment both the first and second current collectors comprise a plurality of aligned and electrically conductive pillar structures that extend from a support face the first/second current collector.

It will be understood that understood that the second current collector 1014 may be provided along a carrier substrate. For example, similar to the first current collector the second (cathode side) current collector can be provided as an electroconductive coat (e.g. of a suitable metal composition as known in the field) that is provided along flexible substrate such as a plastic foil.

FIG. 8 depicts the battery cell product in a charged state, after reaction of the additive salt composition, i.e. after formation the alloy layer 1021 and/or the SEI layer 1022. In such an embodiment, the battery cell product 1000 further includes: an anode layer 1020 comprising an alkali metal and/or alkali earth metal selected from the group consisting of: Na, K, Li, Mg and Cs. Note that the embodiment as depicted does not include an anode metal receptive layer 1010, so that said anode metal is formed as a anode metal layer 1020 that extends between the first current collector 1009 and electrolyte product polymer-based matrix 1003; a mixed metal alloy layer 1021.

In line with another aspect of the present invention there is provided a battery product 2000 (FIG. 10). The embodiment as shown comprises a plurality of the battery cell products 1000. The embodiment as shown comprises a total of five battery cell products 1000-1 to 1000-5 that are arranged in series. Of course a battery product may be provided with a different number that can be arranged in various configurations, including parallel and serial configurations as well as combinations thereof.

The plurality of battery cell products may be arranged in any form suitable known in the field, including but not limited to a pouch or prismatic or button cell format, etc. The battery product can be arranged e.g. in a cylindrical cell format, and may be provided with a cathode side contact 2031, and an anode side contact 2032, to serve as conducting surfaces between the corresponding anode and cathode sides of the plurality of battery cell products and the surrounding environment. The battery product may further be provided with an insulative housing 2030, to protect the plurality of battery cell products from the surrounding environment.

For the purpose of clarity and a concise description, features are described herein as part of the same or separate embodiments, however, it will be appreciated that the scope of the invention may include embodiments having combinations of all or some of the features described.

In interpreting the appended claims, it should be understood that the word “comprising” does not exclude the presence of other elements or acts than those listed in a given claim; the word “a” or “an” preceding an element does not exclude the presence of a plurality of such elements; any reference signs in the claims do not limit their scope; several “means” may be represented by the same or different item(s) or implemented structure or function; any of the disclosed devices or portions thereof may be combined together or separated into further portions unless specifically stated otherwise. Where one claim refers to another claim, this may indicate synergetic advantage achieved by the combination of their respective features. But the mere fact that certain measures are recited in mutually different claims does not indicate that a combination of these measures cannot also be used to advantage. The present embodiments may thus include all working combinations of the claims wherein each claim can in principle refer to any preceding claim unless clearly excluded by context.

1. An electrolyte product (1), suitable for manufacturing a battery cell product, formed as a solid or semi-solid layer (2) comprising a polymer-based matrix (3) having dispersed therein:
an amount of an electrolyte salt composition (4) having cations of an alkali metal and/or an alkaline earth metal (M^{I}) selected from a group consisting of: Na, K, Li, Mg and Cs; and
weakly-coordinating balance anions (X^{I}), and an amount of an additive salt composition (5),
wherein the additive salt composition (5) comprises: cations of a further metal (M^{II}) having a higher reduction potential than (M^{I}); and one or more balance anions (X^{II}) different from (X^{I}) and selected to partake in an SEI-forming redox reaction with the alkali metal and/or an alkaline earth metal, and wherein the solid or semi-solid layer (2) is arranged as a multi-layer stack (6), whereby the additive salt composition (5) is confined to, or at least predominantly contained in, an outer layer (7) of the stack (6).

2. The electrolyte product (1) according to claim 1, wherein the electrolyte product is in a virgin state.

3. The electrolyte product (1) according to claim 1, wherein: M^{I} is Li, M^{II} is an element selected from one or more metals of Group 2 or Group 12-15 elements, and wherein X^{II} is a halide, or a polyatomic anion comprising a central nitrogen atom.

4. The electrolyte product (1) according to claim 1, wherein the matrix (3) comprises 1-30 % by weight of the additive salt composition (5) as based on a total weight of the polymer matrix (3) and the electrolyte (4) and additive salts (5).

5. The electrolyte product (1) according to any of the claim 1, wherein the electrolyte salt composition (4) comprises ≥4 mutually different ones of the weakly-coordinating balance anion (X^{I}).

6. The electrolyte product (1) according to claim 1, wherein the matrix (3) comprises 10-50 % by weight of the electrolyte salt composition (4) as based on a total weight of the polymer matrix (3), the electrolyte (4), additive salts (5) and further additives, if any.

7. The electrolyte product (1) according to claim 1, wherein the electrolyte product (1) is arranged along a face (9f) of a first current collector (9) whereby the outer layer (7) of said the multi-layer stack (6) faces the first current collector (9).

8. The electrolyte product (1) according to claim 7, further comprising an anode metal receptive layer (10) arranged between the electrolyte product (1) and the first current collector (9), the receptive layer (10) containing a receptor material (11), receptive to sorb alkali metal and/or alkaline earth metal, wherein the receptor material (11) comprises one or more of Si, Sn, Li, Mg, and graphite.

9. The electrolyte product (1) according to claim 7, wherein the first current collector (9) comprises a plurality of aligned and electrically conductive pillar structures (12) that extend from a support face (9f) of the first current collector (9), interspaced by at least the electrolyte product (1).

10. The electrolyte product (1) according to claim 1, wherein the polymer-based matrices (3-1, 3-2) in respective layers of the multi-layer stack (6) comprise different polymers.

11. A method of manufacturing a battery cell product (100), said method comprising:
providing the electrolyte product (101) according to claim 1,
providing a first current collector (109), a second current collector (114); a cathode composition (115); and
forming a layered assembly (116), whereby the second current collector (114) extends along a face of the electrolyte product (101) opposite the first current collector (109), and whereby the cathode composition (115) extends between the electrolyte product (101) and the second current collector (114).

12. The method according to claim 11, wherein the layered assembly (116) further comprises an anode metal receptive layer (110) arranged between the electrolyte product (101) and the first current collector (109), the receptive layer (110) containing a receptor material (111), receptive to sorb alkali metal and/or alkaline earth metal, wherein the receptor material (111) comprises one or more of Si, Sn, Li, Mg, and graphite.

13. The method according to claim 11, further comprising depositing an amount of alkali metal and/or alkali earth metal selected from the group consisting of: Na, K, Li, Mg and Cs between the first current collector (109) and the electrolyte product (101).

14. The method according to claim 13, wherein the amount of alkali metal and/or alkali earth metal is provided by electroplating (307) through the electrolyte product (101) which has been pre-assembled onto the first current collector (109).

15. The method according to claim 14, wherein the electroplating (307a) is performed in-situ with a formed layered assembly, whereby an inventory (124) for the electroplating is provided by the cathode composition (115).

16. The method according to claim 14, wherein the electroplating (307b) is performed in a separate electroplating step prior to providing the cathode composition (115) and the second current collector (114).

17. A battery cell product (1000), comprising the electrolyte product (1001) according to claim 1, formed in a layered assembly further including a first current collector (1009), a second current collector (1014), and a cathode composition (1015), whereby the second current collector (1014) extends along a face of the electrolyte product (1001) opposite the first current collector (1009), and whereby the cathode composition (1015) extends between the electrolyte product (1001) and the second current collector (1014).

18. The battery cell product according to claim 17, further comprising an anode metal receptive layer (1010) arranged between the electrolyte product (1001) and the first current collector (1009), the receptive layer containing a receptor material receptive to sorb alkali metal and/or alkaline earth metal, wherein the receptor material (1011) comprises one or more of Si, Sn. Li, Mg, and graphite.

19. The battery cell product according to claim 17, wherein the first current collector (1009) comprises a plurality of aligned and electrically conductive pillar structures that extend from a support face of the first current collector (1009), interspaced by at least the electrolyte product (1001).

20. The battery cell product according to claim 17, wherein the second current collector (1014) comprises a plurality of aligned and electrically conductive pillar structures (1018) that extend from a support face of the second current collector (1014), interspaced by at least the cathode composition (1015).

21. The battery cell product (1000) according to claim 17, wherein the battery cell product (1000) further includes:
an anode layer (1020) comprising an alkali metal and/or alkali earth metal selected from the group consisting of: Na, K, Li, Mg and Cs, said anode layer (1020) extending between the first current collector (1009) and the polymer-based matrix (1003),
a mixed metal alloy layer (1021), said mixed metal alloy layer extending between the anode layer (1020) and the electrolyte product (1001); and
an SEI layer (1022) extending between the mixed metal alloy layer (1021) and the polymer-based matrix (1003),
wherein said mixed metal alloy layer (1021) comprises a mixture of the alkali metal and/or alkali earth metal and a further metal (A) reduced from at least a portion, optionally all, of the M^{II} cations as initially comprised in the electrolyte product (1001),
wherein the SEI layer (1022) comprises at least a portion, optionally all, of the X^{II} anions or reaction products (B) thereof as initially comprised in the electrolyte product (1001), said electrolyte product (1001) comprising an optional remainder of M^{II} and/or X^{II}.

22. The battery cell product (1000) according to claim 17, wherein the battery is in a virgin state.

23. A battery product (2000) comprising one or more electrolyte products (1) according to claim 1 and further comprising additional electrolyte products and/or battery cell products.
